(19) United States
(12) Patent Application Publication
(10) Pub. No.: US 2008/0192907 A1
(43) Pub. Date: Aug. 14, 2008

(54) DUAL-MODE TELECOMMUNICATION DEVICE AND ITS DRIVING METHOD

(75) Inventors: Chin-chung Chen, Jhongli City (TW); Ching-feng Huang, HsinChu City (TW); Yi-chun Sung, HsinChu City (TW)

Correspondence Address: MADSON & AUSTIN, 15 WEST SOUTH TEMPLE, SUITE 900, SALT LAKE CITY, UT, 84101, US

(73) Assignee: Silicon Data International Co., Ltd., Hsin-Chu (TW)

(21) Appl. No.: 11/767,052

(22) Filed: Jun. 22, 2007

(30) Foreign Application Priority Data
Feb. 14, 2007 (TW) 096105517

(51) Int. Cl. H04M 11/00

(52) U.S. Cl. 379/90.01

(57) ABSTRACT

A dual-mode telecommunication device and its driving method are disclosed. The dual-mode telecommunication device electrically connects with a voice input/output communication unit for transmitting/receiving an analog voice signal. In addition, the dual-mode telecommunication device comprises a processor and a switch, wherein the processor is used for detecting/transforming the signal type and generating a control signal based on a detection result. The switch is used for assisting the voice input/output communication unit performing an Internet telecommunication mode or a PSTN (Public Switched Telephone Network) telecommunication mode, alternatively based on the control signal. The driving method is used for determining whether assisting the voice input/output communication unit to electrically connect with the Internet or not by the switch based on detecting a signal which contains an IP, a status result and a dial-tone result of the voice input/output communication unit.

### TECHNICAL FIELD OF THE INVENTION

The present invention relates to a dual-mode telecommunication device and its driving method, and more specifically, to a dual-mode telecommunication device which can assist a voice input/output communication unit interconnecting with an Internet telecommunication mode and a PSTN (Public Switched Telephone Network) telecommunication mode, alternatively, wherein the voice input/output communication unit is used for receiving/transmitting the analog voice signal.

### BACKGROUND OF THE INVENTION

Nowadays, the Internet has become a significant transmission channel in the global community due to widespread use of related technology. By merging the conventional telecommunication network and the Internet, a called VoIP (Voice over Internet Protocol) telephonic device has been gradually developed to be an upcoming mode of telecommunication.

The conventional VoIP telephonic device has a capability of directly interconnecting with the Internet and the PSTN (Public Switched Telephone Network) for performing telecommunication between both networks. In other words, the VoIP telephonic device can assist the conventional telephone to telecommute with the Internet without usage of the computer. In addition, even when the city power fails, the VoIP telephonic device still can perform PSTN telecommunication by a weak power supply from the telephone and telegraph office via the PSTN.

In most of the conventional VoIP telephonic devices, almost all of their control chips has an external memory disposed out of the chip so as to support the built-in function of the control chip, wherein one of the memories usual used is well-known SDRAM (Synchronous Dynamic RAM). Although the SDRAM has an advantage of supporting the built-in function of the control chip for the VoIP telephonic device employing the external memory, when a transmission rate of a bandwidth is increased, the power consumption of the SDRAM will not decrease to minimum at all, and thereby involves the power consumption of the whole VoIP telephonic device.

Besides the control chip, the VoIP telephonic device contains several typical circuits which include, for example a driving circuit, a voltage transforming circuit, a switching circuit and the other usual circuits. Based on essentiality of those electronic circuits, it's difficult to reduce the area occupied with the electronic circuits by way of lessening the amounts of the electronic components. Therefore, both the cost and the size microminiaturization of the electronic components would be important considerations for the circuit board design in the VoIP telephonic device. If the circuit board of the VoIP telephonic device is not only disposed with those typical electronic circuits, but also with an external memory, the size of the circuit board required must be substantially increased. This would result in cost increase and a larger size requirement for the VoIP telephonic device.

Therefore, it is essential to provide a dual-mode telecommunication device, which has a decreased product size and greater cost savings in the manufacturing thereof.

### SUMMARY OF THE INVENTION

To resolve the above drawbacks, a prima objective of the present invention is to provide a dual-mode telecommunication device, which is capable of alternatively switching a voice input/output communication unit to perform either an Internet telecommunication mode or a PSTN telecommunication mode, wherein the voice input/output communication unit is used for receiving/transmitting an analog voice signal.

Furthermore, another objective of the present invention is to provide a driving method applied for said dual-mode telecommunication device, which can perform either the Internet telecommunication mode or the PSTN telecommunication mode, wherein the voice input/output communication unit is used for receiving/transmitting the analog voice signal.

To achieve the above objectives, the present invention provides a dual-mode telecommunication device to electrically connect with a voice input/output communication unit, such as a conventional telephone or a fax machine, for receiving/transmitting an analog voice signal. The dual-mode telecommunication device includes essentially a processor and a switch, wherein the processor has the following capabilities of detecting the voice signal type, performing a signal transformation between the analog voice signal and the digital voice signal, and generating a control signal based on the detected signal type and/or an instruction from the voice input/output communication unit. The instruction is realized as a dial-tone signal by a keystroke. Accordingly, a digital voice signal received from the Internet can be transmitted by the processor to the voice input/output communication unit, or an analog voice signal received from the voice input/output communication unit can be transmitted by the processor to the Internet. In light of the aforementioned control signal, the switch alternatively switches the voice input/output communication unit to perform either an Internet telecommunication mode or a PSTN telecommunication mode.

Additionally, in accordance with a driving method for said dual-mode telecommunication device of the present invention, the dual-mode telecommunication device comprises a processor which is individually connected with both the voice input/output communication unit and the Internet, wherein the voice input/output communication unit is used for receiving/transmitting the analog voice signal, and the Internet is used for receiving/transmitting the digital voice signal. Besides the processor, the dual-mode communication device also comprises a switch which is individually connected with both the voice input/output communication unit and PSTN. Thereby, the driving method herein comprises the following steps:

1. The processor is utilized to detect whether a digital voice signal with an IP (Internet Protocol) is received or not;

2. If the received digital voice signal contains an IP therein, then the processor is utilized further to detect whether the voice input/output communication unit is being used or not;

3. If the received digital voice signal does not contain an IP therein and the voice input/output communication unit is being used, then the processor is utilized to further detect whether the voice input/output communication unit generates a dial-tone signal or not, or else keeping the voice input/output communication unit connected with the PSTN to perform the PSTN telecommunication mode;

4. If the received digital voice signal contains an IP but the voice input/output communication unit is not being operated, or the voice input/output communication unit truly generates a dial-tone signal, then the processor is utilized to transform the received digital voice signal to an analog voice signal and further generate a control signal;

5. In accordance with different levels of the control signal mentioned in the step 4, the switch is utilized either to switch the voice input/output communication unit to connect with the Internet so as to transmit the analog voice signal to the voice input/output communication unit for performing the Internet telecommunication mode, or to keep the voice input/output communication unit connected with the PSTN for performing the PSTN telecommunication mode.

As described above, by the dual-mode telecommunication device and its driving method in accordance with the present invention, it is achieved that the device has a substantially decreased volume and greater cost savings in the manufacturing thereof.

### BRIEF DESCRIPTION OF THE DRAWINGS

The present invention will be apparent to those skilled in the art by reading the following description of preferred embodiments thereof, with reference to the attached drawings, in which:

FIG. 1 is a diagram illustrating a structure of a dual-mode telecommunication device according to the embodiment of the present invention;

FIG. 2 is a diagram illustrating a structure of a processor for the dual-mode telecommunication device according to the embodiment of the present invention;

FIG. 3 is a diagram illustrating a structure of a switch for the dual-mode telecommunication device according to the embodiment of the present invention;

FIG. 4 is a diagram illustrating a structure of a Digital Signal Processor (DSP) device according to the embodiment of the present invention; and

FIG. 5 is a diagram illustrating a flow chart of a method for driving the dual-mode telecommunication device according to the embodiment of the present invention.

### DETAILED DESCRIPTION OF THE INVENTION

The present invention will now be described more specifically with reference to the following embodiments. It is to be noted that the following description of the preferred embodiments of the present invention are presented herein for purpose of illustration and description only and it is not intended to be exhaustive or to be limited to the precise form disclosed.

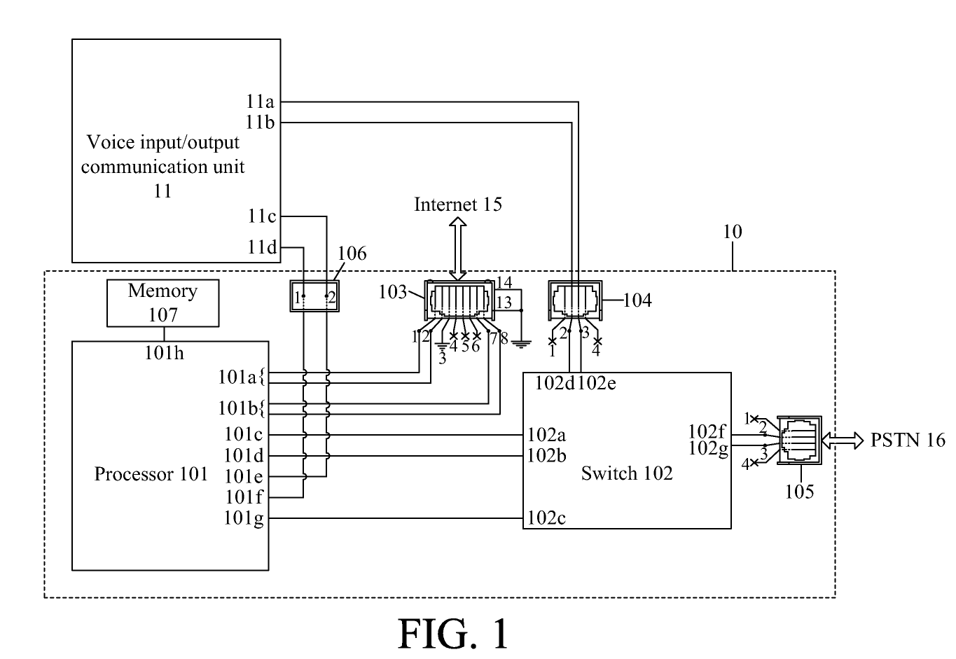

Referring to FIG. 1, a dual-mode telecommunication device 10 according to a preferred embodiment of the present invention will be detailed below, which comprises a processor 101 for individually connecting to both of a voice input/output communication unit 11 and the Internet 15. The voice input/output communication unit is 11 (such as a conventional telephone or a fax machine) is used for receiving/transmitting an analog voice signal, and the Internet 15 is used for receiving/transmitting a digital voice signal. Furthermore, the dual-mode telecommunication device 10 comprises a switch 102 which is individually electrically connected with the process 101, the voice input/output communication unit 11 and a Public Switched Telephone Network (PSTN) 16.

The processor 101 has the following capabilities: detecting the voice signal type, performing a signal transformation between the analog voice signal and the digital voice signal, and generating a control signal for being transmitted to the switch 102, based on a data detected from the internet 15 (such as the data contains an Internet Protocol (IP)) and/or an instruction outputted from the voice input/output communication unit 11. The instruction can be realized as a dial-tone signal by a specific keystroke on the voice input/output communication unit 11. Accordingly, a digital voice signal received from the Internet 15 can be transmitted by the processor 10 to the voice input/output communication unit 11, with signal transformation and conducting of the switch 102, or an analog voice signal received from the voice input/output communication unit 11 can be transmitted by the processor 101 to the Internet 15, with signal transformation and conducting of the switch 102. In accordance with different levels (High/Low) of the aforementioned control signal, the switch 102 switches the voice input/output communication unit 11 to electrically connect with either the Internet 15 via the processor 101 so as to perform an Internet telecommunication mode, or the PSTN 16 via the processor 101 so as to perform a PSTN telecommunication mode.

The dual-mode telecommunication device 10 further comprises an Internet port 103, an audio port 104, a PSTN port 105, a connecter 106 and a memory unit 107.

As described above, the Internet port 103 such as a typical RJ-45 port is used for interconnecting with both the processor 101 and the Internet 15 so as to build up a telecommunication with the Internet 15. As shown in FIG. 1, the Internet port 103 has several pins numerated from 1 to 8 in sequence from the left to right. With this embodiment, the pin 1 (as TPTX+), pin 2 (as TPTX−), pin 7 (as TPRX+) and pin 8 (as TPRX−) are individually electrically connected with the processor 101, and the pin 3 is grounded. The Internet port 103 further has two ground wires 13 and 14 respectively disposed within the inner and outer metallic housings for decreasing the EMI (Electromagnetic Interference) and stabilizing telecommunication quality of the Internet 15.

The audio port 104, such as a typical RJ-11 port, interconnects with both the switch 102 and the voice input/output communication unit 11 so as to transmit a caller-ID, a ringing tone, an analog voice signal to the voice input/output communication unit 11 or receive an analog voice signal outputted from the voice input/output communication unit 11. As shown in FIG. 1, the audio port 104 has several pins numerated from 1 to 4 in sequence from the left to right. With this embodiment, the pin 2 (as a Tip pin) and pin 3 (as a Ring pin) of the audio port 104 are individually electrically connected with the switch 102 and the voice input/output communication unit 11.

The PSTN port 105 such as a typical RJ-45 port is used for interconnecting with both the switch 102 and the PSTN 16 so as to build up a telecommunication with the PSTN 16. As shown in FIG. 1, the PSTN port 105 has several pins numerated from 1 to 4 in sequence from the top to down, wherein the pin 2 (as a Tip pin) and pin 3 (as a Ring pin) of the PSTN port 105 are individually electrically connected with the switch 102. The connecter 106 interconnects with both the processor 101 and the voice input/output communication unit 11, in this embodiment, has at least one contact used for transmitting a dial-tone signal and/or a status signal to the processor 101, wherein the dial-tone signal and the status signal both are outputted from the voice input/output communication unit 11. The memory unit 107, such as a typical Flash Memory, is used to connect with the processor 101 for loading a transformation program to the processor 101, wherein the transformation program is pre-stored inside the memory unit 107.

As shown in FIG. 1, the processor 101 has not only two first input/output pins 101e, 101f, a second input/output pin 101g and two third input/output pins 101c, 101d but also has a plurality of pins 101a, 101b and 101h, wherein the first input/output pins 101e, 101f are individually electrically connected with the connecter 106 for receiving the dial-tone signal and the status signal both which are outputted from the voice input/output communication unit 11. The second input/output pin 101g is used for transmitting the control signal generated by the processor 101 to the switch 102. The third input/output pins 101c, 101d are individually electrically connected with the switch 102 for transmitting the caller-ID, the ringing tone or the transformed analog voice signal to the switch 102, which are generated by the processor, or receiving an analog voice signal generated by the voice input/output communication unit 11 via the switch 102. The pin 101a is electrically connected with both the pin 1 (TPTX+) and pin 2 (TPTX−) of the Internet port 103 for receiving data from the Internet 15. The pin 101b is electrically connected with both the pin 7 (TPRX+) and pin 8 (TPRX−) of the Internet port 103 for transmitting the transformed digital voice signal or a busy tone to the Internet 15, which are generated by the processor 101. The pin 101h is electrically connected with the memory unit 107 for receiving the transformation program which is pre-stored inside the memory unit 107.

Referring to illustration of FIG. 1, the switch 102 has a plurality of pins numerated from 102a to 102g. The pins 102a, 102b of the switch 102 are individually electrically connected with the third input/output pins 101c, 101d of the processor 101 for receiving the caller-ID signal, the ringing tone and the analog voice signal transformed by the processor 101 via the third input/output pins 101c, 101d. Also, the pins 102a, 102b transmit the analog voice signal received from the audio port 104 to the third input/output pins 101c, 101d. The pin 102c is electrically connected with the second input/output pin 101g of the processor 101 for receiving the control signal transmitted from the second input/output pin 101g. The pins 102d, 102e are individually electrically connected with the pins 2, 3 of the audio port 104 for receiving the analog voice signal transmitted from the audio port 104. Also the pins 102d, 102e transmit the analog voice signal transformed by the processor 101 to the audio port 104. The pins 102f, 102g of the switch 102 are individually electrically connected with the pins 2, 3 of the PSTN port 105 for transmitting the analog voice signal to the PSTN port 105. Also the pin 102f and the pin 102g is used to receive the analog voice signal outputted from the PSTN port 105.

Moreover, two pins 11a, 11b of the voice input/output communication unit 11 are individually electrically connected with the audio port 104 for transmitting the analog voice signal to the switch 102, which is received by the voice input/output communication unit 11 via the audio port 104. Furthermore, the pins 11a, 11b can not only receive the caller-ID signal and the ringing tone transmitted from both the audio port 104 and the switch 102 but also receive the analog voice signal transformed by the processor 101 or the PSTN 16. In addition, two pins 11c, 11d of the voice input/output communication unit 11 are individually electrically connected with the connector 106 for transmitting the dial-tone signal and/or the status signal to the processor 101, both which are received by the voice input/output communication unit 11 via the connector 106.

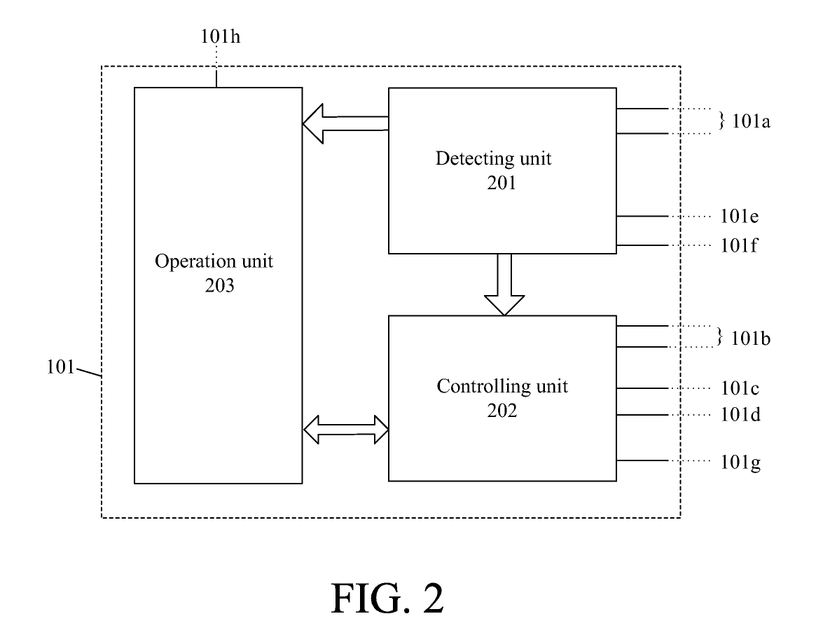

Referring to FIG. 2, a functional block diagram of the processor 101 for the dual-mode telecommunication device 10 according to the embodiment of the present invention is illustrated. As shown in FIG. 2, the processor 101 principally consists of a detecting unit 201, a controlling unit 202 and an operation unit 203, wherein the detecting unit 201 is electrically connected with the controlling unit 202 and the operation unit 203 along a single direction. The controlling unit 202 is electrically connected with the operation unit 203 along bi-directions. The operation unit 203 is used for storing a transformation program which is transmitted from the memory unit 107 so as to perform the signal transformation between the analog voice signal and the digital voice signal.

Under a manner that the city power is being supplied, the detecting unit 201 keeps detecting whether the data (i.e. the digital voice signal) transmitted from the Internet 15 via the pin 101a contains an IP (Internet Protocol) or not. Then a detection result is generated based on said data which contains an IP. If the detection result indicates that the data contains the IP, then the detecting unit 201 further detects whether a status signal transmitted from at least one of the first input/output pins 101e and 101f is found for determining whether the voice input/output communication unit 11 is being used or not, and thereby generates a status result based on the status signal. If the said status result indicates that the voice input/output communication unit 11 is not being used, then the detecting unit 201 transmits the detection result, the status result and a caller-ID contained within the data from the Internet 15 to the controlling unit 202. In light of the aforementioned status result, the controlling unit 202 generates a control signal for being transmitted to the switch 102 via the second input/output pin 101g so as to switch the voice input/output communication unit 11 to perform an Internet telecommunication mode. In other words, the voice input/output communication unit 11 is being telecommunicated with the Internet 15. On this moment, the operation unit 203 perform the transformation program stored in the memory unit 107 via the pin 101h so as to utilize the controlling unit 202 to read out a ringing tone signal from the operation unit 203, and thereby transmit the caller-ID, the ringing tone signal and the transformed analog voice signal to the switch 102 via the third input/output pins 101c, 101d. Furthermore, the switch 102 transmits the transformed analog voice signal to the voice input/output communication unit 11 via the audio port 104.

Under the manner that the dual-mode telecommunication device 10 performs the Internet telecommunication mode, if the user provides an analog voice signal from the voice input/output communication unit 11, via the switch 102, the third input/output pins 101c, 101d, in response to the processor 101, the controlling unit 202 is used to transmit the analog voice signal to the operation unit 203 for performing the signal transformation between the analog voice signal and the digital voice signal, and then operation unit 203 transmits the transformed digital voice signal back to the controlling unit 202b. Furthermore, the controlling unit 202b transmits said transformed digital voice signal to the Internet port 103 for a remote user in the Internet 15.

During the detecting process, if the detection result generated by the detecting unit 201 indicates that the data of the Internet 15 contains the IP and the status result indicates that the voice input/output communication unit 11 is on an in-use status therein, then the detecting unit 201 transmits the detection result and the status result to the controlling unit 202. In this moment, the controlling unit 202 reads out a busy tone signal from the operation unit 203 based on the detection result and the status result, and then transmits the busy tone signal to the Internet port 103 via the pin 101b for transmission of the Internet 15.

Accordingly, under the manner that the city power is being supplied, if the detection result generated by the detecting unit 201 indicates that the data of the Internet 15 does not contain the IP, then the detecting unit 201 will further detect whether the status signal is found at least one of the first input/output pins 101e, 101f for determining whether the voice input/output communication unit 11 is being used or not, and then generates a status result based on the status signal. If said status result indicates that the voice input/output communication unit 11 is on an out-use status, then the detecting unit 201 renews to detect the data of the Internet 15. Oppositely, if the status result indicates that the voice input/output communication unit 11 is on an in-use status, then the detecting unit 201 will further determine whether the dial-tone signal received by one of the first input/output pins 101e, 101f is generated from a specific keystroke or not for determining whether the voice input/output communication unit 11 needs to perform the Internet telecommunication mode or not, and then generate a dial-tone result based on the dial-tone signal. In this embodiment, the specific keystroke is default on at least one of various numbers ‘*’, ‘#’ or ‘070’. However, the present invention should not be limited by the aforementioned description, said keystroke can be modified upon the user demands.

If the dial-tone result indicates that the dial-tone signal is not generated by the specific keystroke, then the detecting unit 201 renews to detect the data of the Internet 15. Oppositely, if the dial-tone result indicates that the dial-tone signal is generated by the specific keystroke, the detecting unit 201 will transmit both the status result and the dial-tone result to the controlling unit 202, and then the controlling unit 202 generates a control signal based on the dial-tone result and transmits the control signal to the switch 102 via the second input/output pin 101g for performing the Internet telecommunication mode. In other word, the voice input/output communication unit 11 will be switched to telecommunicate with the Internet 15.

However, under the Internet telecommunication mode, the analog voice signal generated from the voice input/output communication unit 11 is transmitted to the processor 101 via the switch 102 and the third input/output pins 101c, 101d, and then the analog voice signal is further transmitted by the controlling unit 202 of the processor 101 to the operation unit 203 for the signal transformation into the digital voice signal. The transformed the digital voice signal is sent back to the controlling unit 202 so as to transmit the digital voice signal to the Internet 15 via the internet port 103. In opposition, the digital voice signal responded from a remote user of the internet 15 via the pin 101a is transmitted from the detecting unit 201 to the operation unit 203 for performing the signal transformation into the analog voice signal. The transformed analog voice signal is further transmitted to the controlling unit 202. The controlling unit 202 transmits the transformed analog voice signal to the switch 102 via the third input/output pins 101c, 101d, and then the switch 102 transmits the transformed analog voice signal to the voice input/output communication unit 11 via the audio port 104.

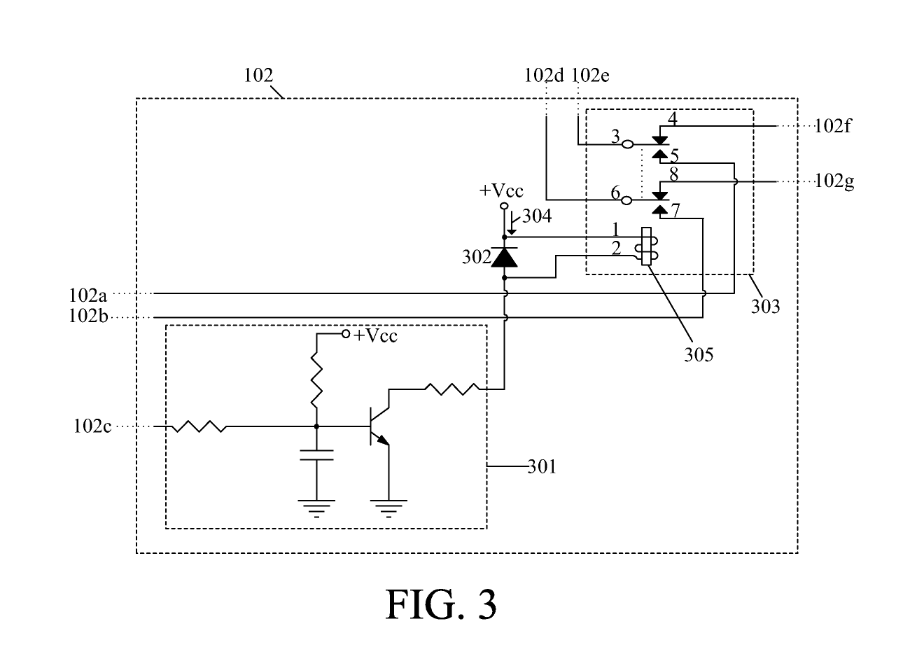

Referencing to FIG. 3, a schematic circuitry of the switch 102 for the dual-mode telecommunication device 10 according to the embodiment of the present invention is illustrated, which has an amplification unit 301, a diode 302 and a relay 303. The diode 302 interconnects between the amplification unit 301 and the relay 303 to act as a protection circuit. Two pins 3, 4 of the relay 302 are merged as a normally-close switch, and two pins 6, 8 of the relay 302 are merged as a normally-close switch, too. Meanwhile, the pins 3 6 of the realy 302 are individually connected with the voice input/output communication unit 11 via the pins 102d, 102e and the audio port 104. The pins 4, 8 of the realy 302 are individually connected with the PSTN 16 via the pins 102f, 102g and the PSTN port 105.

Under a manner that the city power is being supplied, the pin 102c retains a low-level signal since the pin 102c does not receive a control signal yet, which is transmitted from the processor 101. As shown in FIG. 3, the amplification unit 301 is realized as an inverted amplifying circuit. The low-level signal is processed by the amplification unit 301 with an inverted amplification operation to form a high-level signal. Since the high level signal is probably identical with a total voltage (+Vcc), there is no level difference measured between the pins 1, 2 of the relay 303. In other words, the electrical connection between the pins 1, 2 of the relay 303 is established as an open circuit to cause a total current 304 fail. Alternatively, the high-level signal could be greater than the total voltage (+Vcc) to forwardly bias the diode 302 to be conductive in parallels with the pins 1, 2 of the relay 303. In other words, the electrical connection between the pins 1, 2 of the relay 303 becomes a short circuit to cause that the total current 304 flows along an opposite direction with relation to an arrow indicated as shown in FIG. 3, and will not pass through the relay 303.

However, the aforementioned two conditions can not assist the relay 303 to be performed. In other words, the pin 3 of the relay 303 is still electrically connected with the pin 4, and the pin 6 of the relay 303 is electrically connected with pin 8. As described above, the pins 3, 6 are individually electrically connected with the voice input/output communication unit 11 via the pins 102d, 102e and the audio port 104. The pins 4, 8 are individually electrically connected with the PSTN 16 via the pins 102f, 102g and the PSTN port 105. Thereby, the voice input/output communication unit 11 can telecommunicate with the PSTN 16 for performing the PSTN telecommunication mode.

While the dual-mode telecommunication device 10 performs the Internet telecommunication mode, the pin 102c firstly receives the high-level control signal transmitted from the processor 101, and then transmits the high-level control signal to the amplification unit 301. The high-level control signal will be processed by the amplification unit 301 with an inverting amplification operation for generating a low-level control signal. The low-level control signal is lower than the total voltage (+Vcc) so as to constitute a level difference measured between the pins 1, 2 of the relay 303, Thereby, the diode 302 fails to be conductive due to a reverse bias formed between the pins 1, 2 of the relay 303. It causes that the total current 304 flows along the same direction as an arrow indicated as shown in FIG. 3, from high to a low level, as from the pin 1 to the pin 2 of the relay 303.

As soon as the total current 304 flows through pin 1 to pin 2 of the relay 303, a magnetic field is induced around a coil 305 disposed between the pins 1, 2 of the relay 303 because of an induction law effect. Thereby, the pin 3 is attracted with the pin 5 and pin 6 is attracted with pin 7 for electrical connection. The pins 5, 7 are individually connected with the Internet 15 via the pins 102a, 102b, the processor 101 and the Internet port 103. As described above, the pin 3, pin 6 are individually electrically connected with the voice input/output communication unit 11 via the pins 102d, 102e and the audio port 103. Thereby, the voice input/output communication unit 11 can telecommute with the Internet 15 for performing the Internet communication mode.

However, under a manner that the city power fails to be supplied, the pin 3 of the relay 302 is still electrically connected with the pin 4 of the same, and the pin 6 of the relay 302 is still electrically connected with the pin 8 of the same since the pins 3, 4 of the relay 302 are merged as a normally-close switch, and the pins 6, 8 of the relay 302 are merged as the normally-close switch, too. In other words, the voice input/output communication unit 11 is still electrically connected with the PSTN port 105 to perform the PSTN telecommunication mode, by way of receiving the 48V feed-voltage and 25 mA feed current which are supplied from the telephone and telegraph office.

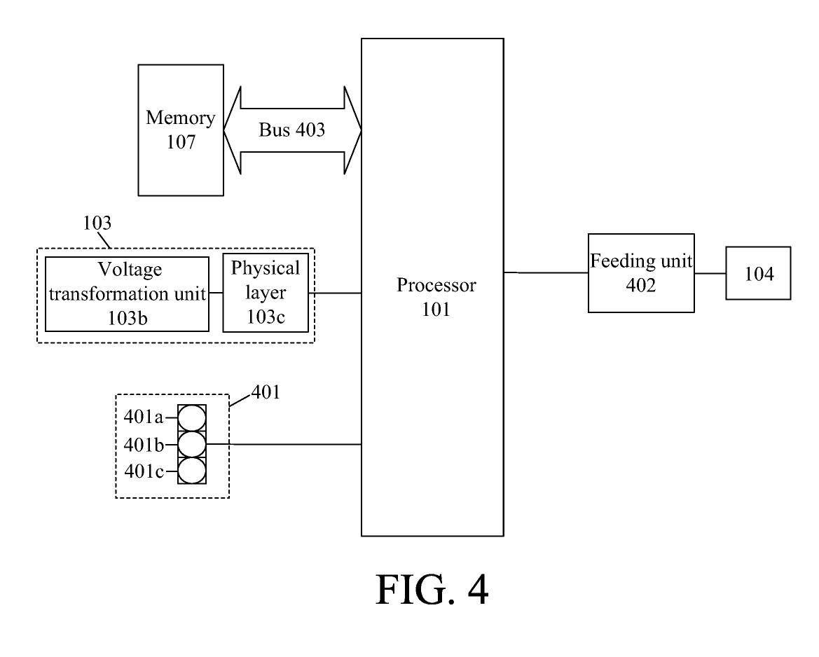

Referring to FIG. 4, a schematic structure diagram of the processor 101 according to the preferred embodiment of the present invention is illustrated. The processor 101 can be realized as a Digital Signal Processor (DSP) in this embodiment, and electrically connects with the memory 107, the audio port 104, the Internet port 103 and a display device 401.

As shown in FIG. 4, the processor 101 communicates with the memory unit 107 via a bus 403. While the processor 101 is switched to perform the Internet telecommunication mode, the processor 101 loads a transformation program pre-stored within the memory unit 107 via the bus 403 for performing the signal transformation operation. In addition, the Internet port 103 electrically connected with the processor 101, comprises therein a voltage transformation unit 103b and a physical layer 103c which interconnects with the voltage transformation unit 103b. Thereby, the voltage transformation unit 103b is used for transform an AC (Alternate Current) voltage to a DC (Directly Current) voltage wherein which the AC voltage is received from the Internet 15. The physical layer 103c is used for transform the data received from the Internet 15 into a signal (e.g. 0 or 1) that could be operated by the processor 101.

The audio port 104 is connected with the processor 101 via a feed unit 402. However, the feed unit 402 also can be built inside the audio port 104 for receiving the 48V feed-voltage and 25 mA feed current supplied from the telephone and telegraph office, and then transmit both the feed-voltage and the feed current to the voice input/output communication unit 11. Moreover, the display device 401 comprises a physical indicating light 401a, a connection indicating light 401b and a dual-mode indicating light 401c. The indicating display light 401a utilizes its light brightness to indicate that the Internet port 103 has been electrically connected with the Internet 15. The connection indicating light 401b utilizes its light brightness to indicate that the audio port 104 has been electrically connected with the voice input/output communication unit 11. The dual-mode indicating light 401c utilizes its light brightness to indicate that the voice input/output communication unit 11 is performing the Internet telecommunication mode.

In the embodiment of the present invention, an external voltage transformation circuit is unnecessary since the Internet port 103 has a voltage transformation unit 103b disposed therein and still retains a capability of transforming the AC voltage into the DC voltage. In addition, since the transformation program is constructed in an “Assembly” program language, the memory size occupied with the transformation program in the memory unit 107 can be substantially reduced to a minimization and even all of the transformation program can be written in the memory unit 107, without the need of using an external memory for storing the transformation program as the same as a conventional DSP device.

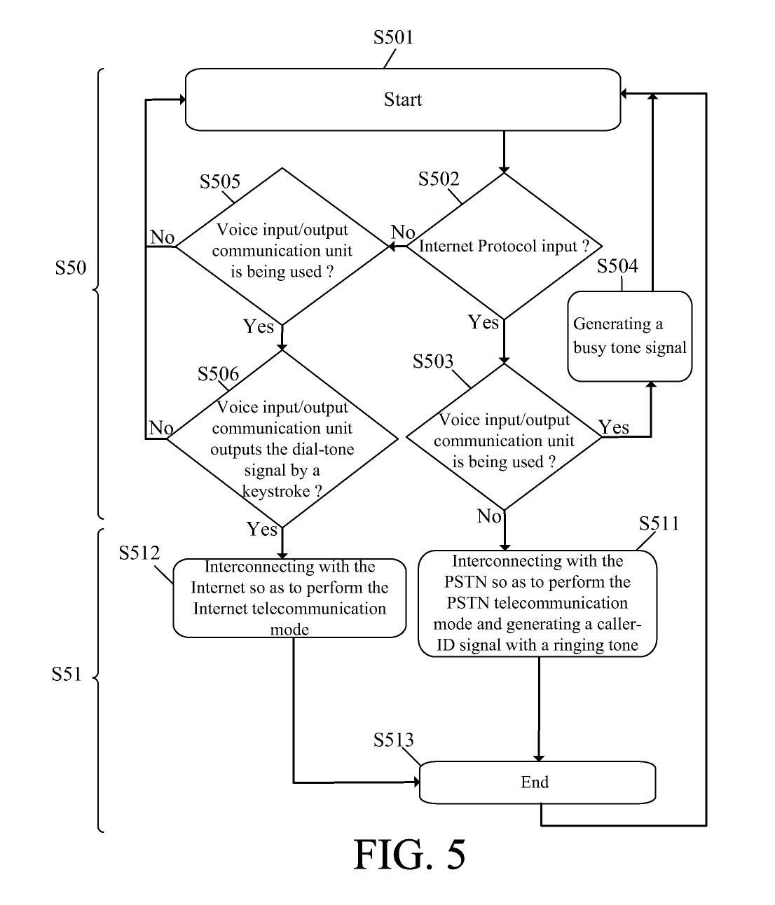

Referring to FIG. 5, a flow chart of a method of driving a dual-mode telecommunication device 10 according to a preferred embodiment of the present invention, which consists of two essential processes, one of which is a detection process S50, and the other of which a controlling process S51. The detection process S50 comprises the steps from S501 to S506, and the controlling process S51 comprises the steps from S511 to S513. In accordance with a driving method for the dual-mode telecommunication device 10 of the present invention, the detection process S50 is firstly used for detecting various signal types. If a result that the Internet telecommunication mode is being performed is determined during the detection process S50, then the controlling process S51 is used for finishing the Internet telecommunication mode. The detection process S50 and the controlling process S51 will be described below in details.

Initially, the voice input/output communication unit has been electrically connected with said dual-mode telecommunication device in the embodiment of the present invention, wherein the dual-mode telecommunication device is individually connected with the Internet 15 and the PSTN 16. The voice input/output communication unit can be a typical telephone or a fax machine. As described above, said dual-mode telecommunication device connect the voice input/output communication unit with the Internet 16 under a manner that the city power is being supplied. In other words, a user can directly telecommute with the PSTN by the voice input/output communication unit to perform the PSTN mode under the manner that the city power is being supplied. For this reason, the following steps is described based on the Internet telecommunication mode.

In step S501, the voice input/output communication unit is initialized to electrically connect with the PSTN 16 for performing the PSTN mode.

Furthermore, in step S502, the dual-mode telecommunication device keeps receiving the data which is transmitted from the Internet 15, and then detecting whether the data of the Internet 15 contains an Internet IP therein or not. If the data of the Internet 15 containing an IP is found, then the data will be processed as described in step S503. However, if the data of the Internet 15 is found without an IP, then the data will be further processed as described in step S505. As shown in FIG. 5, the steps from S503 to S513 is a telecommunication process of receiving any call from the Internet 15, and the steps from S505 to S513 is another type telecommunication process of dialing a call to the Internet 15. The following steps describe the telecommunication process of receiving the call from the Internet 15.

In step S503, the dual-mode telecommunication device detects whether the voice input/output communication unit is being used or not. If a detecting result indicates that the voice input/output communication unit is in an in-use status, and then the voice input/output communication unit transmits a busy tone signal back to the Internet 15 as performing a step S504. However, if the result indicates that the voice input/output communication unit is in an out-use status, and then in the step S511 the voice input/output communication unit interconnects with the Internet 15 for performing the Internet telecommunication mode, and generates a caller-ID and a ringing tone for informing the user about that. In step S513, when the user uses the voice input/output communication unit to perform the Internet telecommunication mode until the telecommunication ends, the voice input/output communication unit renews back to the initial status as the step S501. It means that the voice input/output communication unit is kept to be electrically connected with the PSTN 16 for performing the PSTN telecommunication mode in the next process.

In the step S503, if the result indicates that the voice input/output communication unit is in an in-use status, and receives an analog voice signal which is transmitted from the PSTN 16 at the same time, then the dual-mode telecommunication device will transmit an interrupting tone back to the PSTN 16.

In step S505, while the user would like to make a phone call via the Internet 15, the dual-mode telecommunication device can detect whether the voice input/output communication unit is being used or not. If the defecting result indicates that the voice input/output communication unit is in an in-use status, then the voice input/output communication unit will operate as the step S506. However, if the detecting result indicates that the voice input/output communication unit is in an out-use status, then the voice input/output communication unit will renew to the initial status as described in the step S501. It means that the voice input/output communication unit is kept to be electrically connected with the PSTN 16 for performing the PSTN telecommunication mode in the next process. In step S506, the dual-mode telecommunication device receives the dial-tone signal which is transmitted from the voice input/output communication unit and then detects whether the dial-tone signal is generated by a specific keystroke or not (e.g. *, # or 070) for determining whether to perform the Internet telecommunication mode or not. If the result indicates that the dial-tone signal is generated by a specific keystroke, then the voice input/output communication unit will operate as the step S512. However, if the result indicates that the dial-tone signal is not generated by the specific keystroke, then the voice input/output communication unit will renew to the initial status as described in the step S501. It means that the voice input/output communication unit is kept to be electrically connected with the PSTN 16 for performing the PSTN telecommunication mode in the next process. Furthermore, the dual-mode telecommunication device can assists the voice input/output communication unit to connect with the Internet 15 for performing the Internet telecommunication mode as the step S512. When the user utilizes the voice input/output communication unit to perform the Internet telecommunication mode until the telecommunication is finished as the step S513, then the voice input/output communication unit will renew to the initial status in step S501. Accordingly, the voice input/output communication unit is kept to be electrically connected with the PSTN 16 for performing the PSTN telecommunication mode in the next process.

In conclusion, by the dual-mode telecommunication device and its driving method in accordance with the present invention, it is achieved that the device has a substantially decreased volume and greater cost savings in the manufacturing thereof.

While the preferred embodiment of the present invention has been described in details, various modifications and alterations can be made by persons skilled in this art. The embodiment of the present invention is therefore described in an illustrative but not in a restrictive sense. It is intended that the present invention should not be limited to the particular forms as illustrated, and that all modifications and alterations which maintain the same spirit, realm, or function of the present invention are within the scope as defined in the appended claims.

What is claimed is:

1. A dual-mode telecommunication device which is connected with both a voice input/output communication unit and the Internet, wherein the voice input/output communication unit is used for receiving/transmitting an analog voice signal, and said device comprising:
a processor for performing a signal transformation between the analog voice signal and digital voice signal, furthermore, generating a control signal based on the data received from the Internet so as to transmit the digital voice signal received from the Internet to the voice input/output communication unit, or generating a control signal based on an instruction outputted from the voice input/output communication unit so as to transmit the analog voice signal received from the voice input/output communication unit to the Internet; and
a switch for individually connecting with the processor and the voice input/output communication unit, according to the control signal and the voice signal, switching the voice input/output communication unit to perform either an Internet telecommunication mode or a Public Switched Telephone Network (PSTN) telecommunication mode.

2. The dual-mode telecommunication device according to claim 1, wherein the voice input/output communication unit comprises a conventional telephone or a fax machine.

3. The dual-mode telecommunication device according to claim 1, wherein the processor is connected with a memory unit which contains a transformation program for performing the signal transformation between the analog voice signal and the digital voice signal.

4. The dual-mode telecommunication device according to claim 3, wherein the processor is connected with an Internet port for telecommunicating with the Internet.

5. The dual-mode telecommunication device according to claim 1, wherein the switch is connected with a PSTN port for telecommunicating with the PSTN.

6. The dual-mode telecommunication device according to claim 2, wherein the voice input/output communication unit further comprises an audio port for connecting with the switch.

7. The dual-mode telecommunication device according to claim 1, wherein the processor further comprising:
at least one first input/output pin for receiving the instruction which transmitted from the voice input/output communication unit, wherein the instruction comprises a status signal and/or at least one dial-tone signal;
at least one second input/output pin for transmitting the control signal to the switch; and
at least one third input/output pin for transmitting the analog voice signal transformed by the processor to the switch.

8. The dual-mode telecommunication device according to claim 1 or claim 7, wherein the processor comprises an operation unit, a detecting unit and a controlling unit.

9. The dual-mode telecommunication device according to claim 8, wherein the detecting unit detects whether the Internet data received via the Internet port contains an Internet Protocol (IP) and thereby generates a detection result for being transmitted to the controlling unit.

10. The dual-mode telecommunication device according to claim 9, wherein the detecting unit detects the status signal which is received via the first input/output pins, according to the detection result, so as to determine whether the voice input/output communication unit is being used, and thereby generates a status result for being transmitted to the controlling unit.

11. The dual-mode telecommunication device according to claim 10, wherein the controlling unit generates a control signal according to the status result, and then transmits the control signal to the switch via the second input/output pin.

12. The dual-mode telecommunication device according to claim 11, wherein if the status result indicates an in-use status and the detection result contains the IP, then the detecting unit generates a busy tone for being transmitted to the switch.

13. The dual-mode telecommunication device according to claim 10, wherein the detecting unit detects the dial-tone signal received via the first input/output pins, according to the status result, so as to determine whether the voice input/output communication unit is being connected with the Internet and thereby generates a dial-tone result for being transmitted to the controlling unit

14. The dual-mode telecommunication device according to claim 13, wherein the controlling unit generates the control signal according to the dial-tone result, and then transmits the dial-tone result to the switch via the second input/output pin.

15. The dual-mode telecommunication device according to claim 8, wherein the operation unit is used for storing a transformation program which is transmitted from the memory unit.

16. The dual-mode telecommunication device according to claim 15, wherein the operation unit performs the signal transformation between the digital voice signal and the analog voice signal by using the transformation program, and then transmits a transformation result to the controlling unit wherein the digital voice signal is received from the Internet and the analog voice signal is received from the voice input/output communication unit.

17. The dual-mode telecommunication device according to claim 16, wherein the controlling unit transmits the transformation result to the Internet port so as to perform the Internet telecommunication mode.

18. The dual-mode telecommunication device according to claim 16, wherein the controlling unit transmits the transformation result to the switch via the third input/output pin.

19. The dual-mode telecommunication device according to claim 18, wherein the switch transmits the transformation result to the voice input/output communication unit via the audio port, according to the control signal, so as to perform the Internet telecommunication mode.

20. The dual-mode telecommunication device according to claim 6, wherein the switch interconnects with the PSTN port and the audio port, under a manner that the city power is supplied to the switch.

21. The dual-mode telecommunication device according to claim 20, wherein the switch interconnects with the Internet port and the audio port, according to the control signal, under a manner that the city power is supplied to the switch.

22. The dual-mode telecommunication device according to claim 6, wherein the switch interconnects with the PSTN port and the audio port, under a manner that the city power fails to the switch.

23. The dual-mode telecommunication device according to claim 1, wherein the switch has an amplification unit which comprises an inverted amplifying circuit.

24. The dual-mode telecommunication device according to claim 1, wherein the switch has a passive switch which comprises a relay.

25. A driving method for a dual-mode telecommunication device, wherein the dual-mode telecommunication device comprises a processor which is connected with both a voice input/output communication unit for receiving/transmitting the analog voice signal and the Internet for receiving/transmitting a digital voice signal, and a switch which is connected with both the voice input/output communication unit and a Public Switched Telephone Network (PSTN), said method comprising the following steps of:
utilizing the processor to detect whether to receive a digital voice signal with an Internet Protocol (IP) or a dial-tone signal outputted from the voice input/output communication unit;
according to the detection result, determining a control signal by the processor; and
according to different levels of the control signal, switching the voice input/output communication unit by the switch to perform either an Internet telecommunication mode or a PSTN telecommunication mode.

26. The driving method for a dual-mode telecommunication device according to claim 25, wherein the processor comprises an operation unit, a detecting unit and a controlling unit.

27. The driving method for a dual-mode telecommunication device according to claim 26, further comprising a step of utilizing the detecting unit to generate a detection result and then transmit the detection result to the controlling unit, as soon as the received digital voice signal is found with an IP by the detecting unit.

28. The driving method for a dual-mode telecommunication device according to claim 27, further comprising a step of utilizing the detecting unit to detect the status signal outputted from the voice input/output communication unit, according to the detection result, for determining whether the voice input/output communication unit is being used and thereby generates a status result for being transmitted to the controlling unit.

29. The driving method for a dual-mode telecommunication device according to claim 28, further comprising a step of utilizing the controlling unit to transmit the control signal to the switch as soon as the status result indicates an out-use status.

30. The driving method for a dual-mode telecommunication device according to claim 28, further comprising a step of utilizing a detecting unit to transmit a busy tone to the controlling unit as soon as the status result indicates an in-use status and the detection result contains the IP.

31. The driving method for a dual-mode telecommunication device according to claim 27, further comprising a step of utilizing the detecting unit to generate a dial-tone result for being transmitted to the controlling unit as soon as the detecting unit finds the dial-tone signal outputted from the voice input/output communication unit.

32. The driving method for a dual-mode telecommunication device according to claim 31, further comprising a step of utilizing the controlling unit to generate the control signal according to the dial-tone result and then transmit the control signal to the switch.

33. The driving method for a dual-mode telecommunication device according to claim 26, further comprising a step of utilizing the operation unit to store a transformation program required for the signal transformation between the analog voice signal and the digital voice signal.

34. The driving method for a dual-mode telecommunication device according to claim 33, further comprising a step of utilizing the operation unit to perform the signal transformation between the digital voice signal and the analog voice signal, based on the transformation program, and then transmit a transformation result to the controlling unit, wherein the digital voice signal is received from the Internet and the analog voice signal is received from the voice input/output communication unit.

35. The driving method for a dual-mode telecommunication device according to claim 34, further comprising a step of utilizing the controlling unit to transmit the transformation result to the Internet.

36. The driving method for a dual-mode telecommunication device according to claim 34, further comprising a step of utilizing the controlling unit to transmit the transformation result to the switch.

37. The driving method for a dual-mode telecommunication device according to claim 36, further comprising a step of utilizing the controlling unit to transmit the transformation result to the voice input/output communication unit.

38. The driving method for a dual-mode telecommunication device according to claim 25, further comprising a step of utilizing the switch to individually connect with both the PSTN and the voice input/output communication unit, under a manner that the city power is supplied to the switch.

39. The driving method for a dual-mode telecommunication device according to claim 38, further comprising a step of utilizing the switch to individually connect with either the Internet port or the voice input/output communication unit, according to the control signal, under a manner that the city power is supplied to the switch.

40. The driving method for a dual-mode telecommunication device according to claim 25, further comprising a step of utilizing the switch to individually connect with both the PSTN and the voice input/output communication unit, under a manner that the city power is fails to the switch.
